(19) United States
(12) Patent Application Publication
(10) Pub. No.: US 2007/0208684 A1
(43) Pub. Date: Sep. 6, 2007

(54) Information collection support apparatus, method of information collection support, computer readable medium, and computer data signal

(75) Inventors: Takashi Isozaki, Kanagawa (JP); Noriji Kato, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/503,177

(22) Filed: Aug. 14, 2006

(30) Foreign Application Priority Data
Mar. 6, 2006 (JP) 2006-060078

(51) Int. Cl. G06F 17/30

(52) U.S. Cl. 707/1

(57) ABSTRACT

An information collection support apparatus that presents keyword information used for information collection, the information collection support apparatus includes: a retention unit that retains a candidate of the keyword information extracted from documents to which past work was applied by a user and probability weight information for each user to each of evaluation factors, the evaluation factors including evaluation factors relating to the candidate of the keyword information; a correction unit that corrects the probability weight information based on user's work applied to the documents; and an output unit that outputs the keyword information relevant to each document selected out of a document group using the probability weight information of the evaluation factor.

### BACKGROUND

1. Technical Field

This invention relates to an information collection support apparatus providing a keyword used for a search engine of a web page, etc.

2. Related Art

In recent years, the infrastructure of providing information including the Internet has been built and arts of searching for information provided by the infrastructure have been researched. For example, a service is available for searching for web pages provided on the Internet and providing a list of web pages containing entered keywords.

To find out web pages where information desired by the user is provided, it becomes important to select a keyword; however, the service does not necessarily enable the user to select an appropriate keyword. Then, an agent system, etc., is demanded for estimating a keyword relating to the information desired by the user and presenting documents found using the estimated keyword.

### SUMMARY

According to an aspect of the invention, an information collection support apparatus that presents keyword information used for information collection, the information collection support apparatus includes: a retention unit that retains a candidate of the keyword information extracted from documents to which past work was applied by a user and probability weight information for each user to each of evaluation factors, the evaluation factors including evaluation factors relating to the candidate of the keyword information; a correction unit that corrects the probability weight information based on user's work applied to the documents; and an output unit that outputs the keyword information relevant to each document selected out of a document group using the probability weight information of the evaluation factor.

### BRIEF DESCRIPTION OF THE DRAWINGS

An exemplary embodiment of the present invention will be described in detail based on the following figures, wherein:

FIG. 1 is a block diagram that illustrates a configuration example of an information collection support apparatus according to an embodiment of the invention;

FIG. 2 is a schematic representation that illustrates an example of an evaluation factor database of the information collection support apparatus according to the embodiment of the invention;

FIG. 3 is a schematic representation that illustrates an outline example of a Bayesian network used by the information collection support apparatus according to the embodiment of the invention;

FIG. 4 is a schematic representation that illustrates an example of a database for retaining the numbers of occurrences of keyword information candidates in the information collection support apparatus according to the embodiment of the invention;

FIG. 5 is a schematic representation that illustrates an example of a database for retaining the number of important documents and the number of non-important documents in the information collection support apparatus according to the embodiment of the invention; and

FIG. 6 is a flowchart that illustrates a processing example of the information collection support apparatus according to the embodiment of the invention.

### DETAILED DESCRIPTION

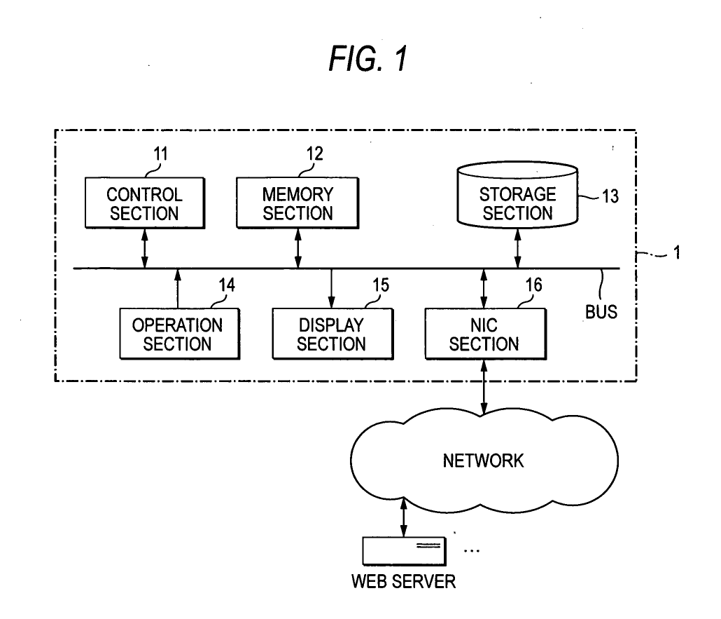

Referring now to the accompanying drawings, there is illustrated a preferred embedment of the invention. An information collection support apparatus 1 according to an embedment of the invention is made up of a control section 11, a memory section 12, a storage section 13, an operation section 14, a display section 15, and a network interface (NIC) section 16, as illustrated in FIG. 1.

The control section 11 is a program control device of a CPU, etc., and operates in accordance with a program stored in the memory section 12. The control section 11 authenticates the user by using the user name, password, etc., for example, and executes processing of creation, browsing (read), deletion, transfer, etc., based on a request received from the authenticated user for a document transmitted and received as electronic mail, a document acquired from a web server, etc., a document stored in the storage section 13, etc. The control section 11 records the user work on the documents as a log.

The control section 11 also calculates the evaluation value based on a predetermined evaluation factor for the document created, browsed (read), etc., by the user. For each user, probability weight information is set in each evaluation factor as described later. The control section 11 corrects the probability weight information for each evaluation factor based on the document work log for each user.

Further, the control section 11 uses the setup probability weight information for each evaluation factor, selects some of predetermined extraction target documents, and extracts keyword information from the selected extraction target documents. The extracted keyword information is presented to the user as the keyword relating to the user's attention documents.

The control section 11 may perform processing of using the extracted keyword information and acquiring and presenting another document group or the like. The specific processing executed by the control section 11 is described later in detail.

The memory section 12 is implemented including a memory device of RAM, ROM, etc. The memory section 12 stores programs executed by the control section 11. The memory section 12 also operates as work memory of the control section 11.

The storage section 13 is a hard disk device, etc., and stores various documents. The storage section 13 also stores a list of keyword information extracted from the documents worked on by the user as a keyword information candidate group.

The operation section 14 is a keyboard, a mouse, etc., and outputs the description of a command entered by the user. The display section 15 is a display, etc., and displays information in accordance with the command input from the control section 11.

The NIC section 16 is connected to a network and sends information through the network in accordance with the command input from the control section 11. The NIC section 16 also outputs information received through the network to the control section 11. In the embodiment, it is assumed that the NIC section 16 is connected to the Internet; it transmits keyword information to a search engine (for example, Google (trademark), etc.,) that can be accessed through the Internet, receives a list of the documents, document entity information, etc., found based on the keyword information, and outputs them to the control section 11.

### [Evaluation Factor of Document]

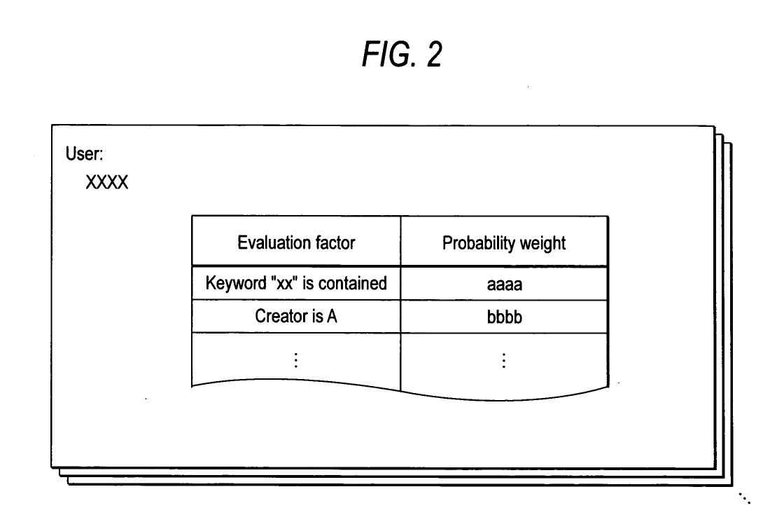

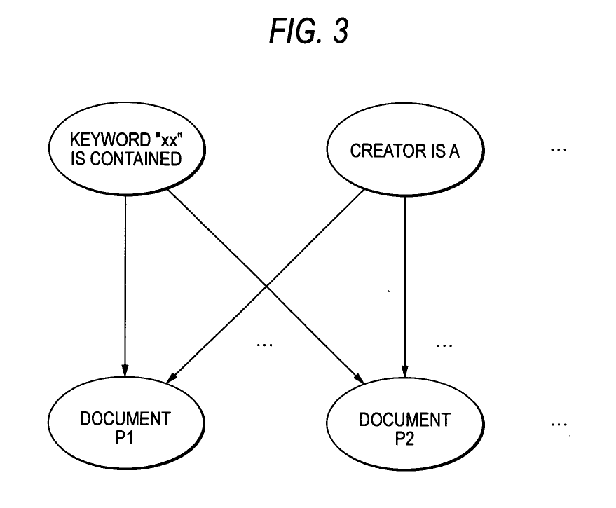

In the embodiment, a condition that predetermined keyword information is contained, a condition that the similarity to a document set to be important in the past is a predetermined value or more, a condition concerning storage location, a condition of creator, and the like are adopted as evaluation factors. For each user, when each evaluation factor is satisfied, probability weight information representing the probability determining that the document is important is related to the evaluation factor for storage in the storage section 13 as an evaluation factor database (FIG. 2). A Bayesian network as illustrated in FIG. 3 conceptually is formed according to the evaluation factor database.

The control section 11 in the embodiment extracts keyword information from the document worked on by the user and adds at least a part of the keyword information to a keyword information candidate list stored in the storage section 13. The evaluation factor database contains the evaluation factor relating to each keyword information candidate belonging to the keyword information candidate list.

The reason why at least a part is added that, for example, only keyword information at a comparatively high extraction frequency and at a comparatively low extraction frequency among all documents stored in the storage section 13 (keyword information with the TF/IDF (Term Frequency/Inverse Document Frequency) value higher than a predetermined threshold value) may be contained in the keyword information candidate list without containing all of extracted keyword information in the keyword information candidate list.

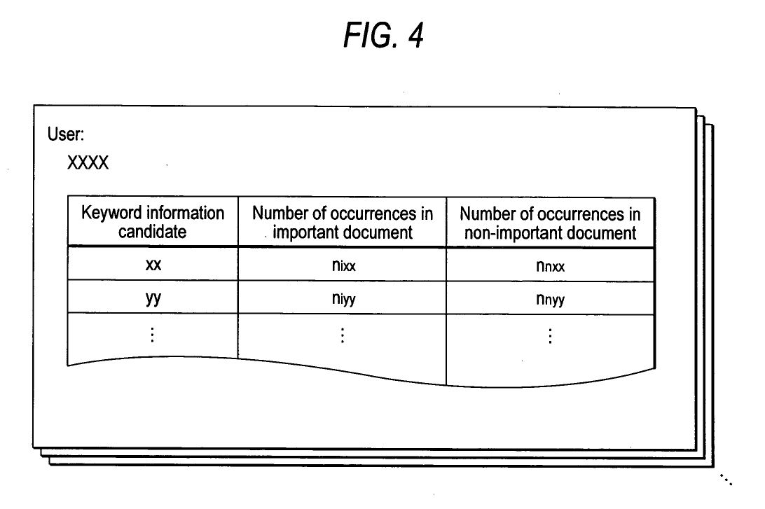

In the keyword information candidate list, for each user, the number of occurrences in a document determined important and the number of occurrences in a document determined non-important are related to each other and are retained as a number-of-occurrences database, as illustrated in FIG. 4. The determination as to whether each document is important or non-important is described below.

### [Processing of Control Section]

Next, the processing of the control section 11 will be discussed. The control section 11 previously authenticates the user and acquires information for identifying the user.

Whenever the user performs work of creating a document of electronic mail, receiving and browsing (reading) a document of electronic mail, or acquiring and browsing (reading) a document on a web server, the control section 11 estimates the importance of each document worked on from the probability weight information concerning the authenticated user, recorded in the evaluation factor database.

The control section 11 computes the probability that the document will be important for the authenticated user and if the probability that the document will be important exceeds a predetermined threshold value, the control section 11 determines that the document is an important document. If the probability that the document will be important does not exceed the predetermined threshold value, the control section 11 determines that the document is a non-important document.

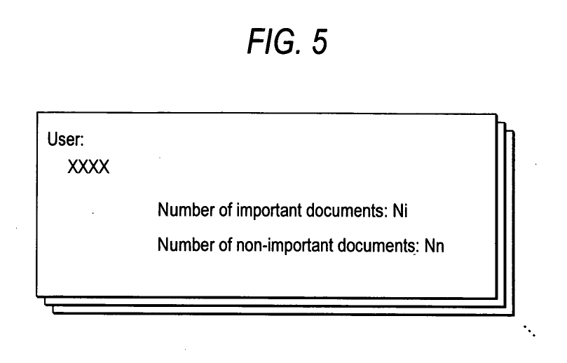

The control section 11 counts the number of the documents determined important and the number of the documents determined non-important among the documents worked on by the user, and stores the information of the number of the documents determined important and the number of the documents determined non-important for each user, as illustrated in FIG. 5.

The control section 11 also searches the documents worked on for each keyword information entry contained in the keyword information candidate list. It increments the information of the number of occurrences related to the keyword information found as a result of the search by one in the number-of-occurrences database. That is, if the document worked on is determined important, the number of occurrences in the document determined important is incremented by one. If the document worked on is determined non-important, the number of occurrences in the document determined non-important is incremented by one.

The control section 11 performs processing of updating the probability weight information recorded in the evaluation factor database from the result of user operation on the document. This processing may be similar to processing based on a learning system with semi-teacher at two stages of profiling and behavior using a Bayesian network, presented by the inventor et al. in T. Isozaki, K. Horiuhchi, and H. Kashimura, “A New E-mail Agent Architecture Based on Semi-supervised Bayesian Networks” presented in International Conference on Computational Intelligence for Modeling Control and Automation—CIMCA′ 2005, for example, and therefore will not be discussed here again in detail. (It is scheduled that the paper will be published by IEEE.)

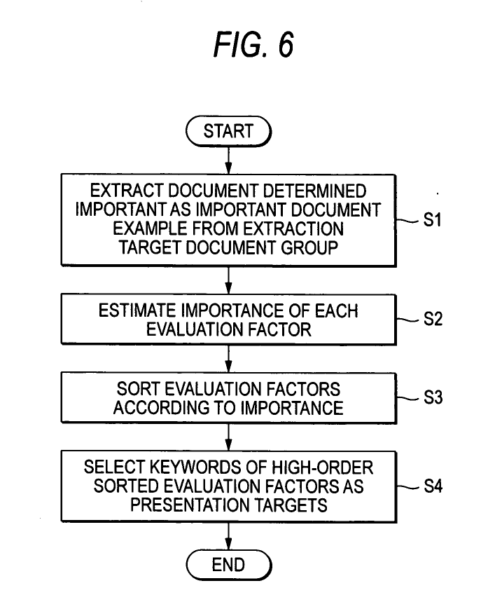

If the user enters a command for presenting a keyword, the control section 11 starts processing illustrated in FIG. 6 upon reception of the command and uses the probability weight information concerning the user, recorded in the evaluation factor database and selects a document determined important out of a predetermined document group (a group of extraction target documents). Here, the documents stored in the storage section 13 (for example, it is assumed that documents downloaded from a web server, documents created by the user, and documents of electronic mail received or transmitted are stored) are adopted as the extraction target documents and the probability weight information concerning the user, recorded in the evaluation factor database is used to select a document determined important from among the extraction target documents.

That is, the control section 11 creates a network with the evaluation factors contained in the evaluation factor database for each of the extraction target documents, and calculates the probability that each extraction target document will be determined important. This means that the probability that each extraction target document will be determined important is calculated from the probability weight information related to each evaluation factor. It is determined that the extraction target document with the probability that the extraction target document will be determined important exceeding a predetermined threshold value in the extraction target document group is an important document example (S1).

On the other hand, Bayes' theorem is a theorem of relating the probability of B when A and a theorem of relating the probability of A when B to each other and therefore if the Bayes' theorem is used, the occurrence probability of each evaluation factor is computed from the probability that the document determined the important document example will be determined important.

Using thus the Bayes' theorem, the control section 11 uses the probability that the important document example will be determined important for each determined important document example to calculate the probability that each evaluation factor occurs, accumulates the occurrence probability computed for each important document example about each evaluation factor, and adopts the accumulation result as the importance of the evaluation factor (S2).

The control section 11 sorts the evaluation factors relating to the keyword information in the descending order of the importance with the importance of each evaluation factor as a key (S3). The control section 11 extracts the keyword information relating to a predetermined number of high-order evaluation factors as the keyword information to be presented (presentation targets) (S4).

The control section 11 may output the keyword information of the presentation targets extracted here to the display section 15, for example. The control section 11 causes the NIC section 16 to transmit the keyword information to be presented to a search engine (for example, Google (trademark), etc.,) that can be accessed through the Internet. The control section 11 receives input of entity information of the document found based on the keyword information from the NIC section 16 and stores it in the storage section 13. The stored document is also handled as the extraction target document. The control section 11 displays the documents obtained as the search result on the display section 15.

A condition that plural keyword information pieces co-occur may be included as an evaluation factor. In this case, for example, if the case where up to n keyword information pieces co-occur in combination about N keyword information candidates is adopted as an evaluation factor, the number of the combinations becomes enormous and the processing burden grows.

Then, keyword information contained in the condition of co-occurrence is previously narrowed down in keyword information candidates. For example, keyword information contained in the document determined important may be taken out as a second candidate from the past work results and an evaluation factor relating to the condition of co-occurrence may be set about combinations about the second candidates.

As a condition for taking out as second candidates, for example, for each keyword information piece, the value of

$$( \frac{{n}_{i}}{{n}_{i} + {n}_{n}} - \frac{{N}_{i}}{{N}_{i} - {N}_{n}} ) \times {n}_{i}$$

may be computed and the keyword information pieces may be sorted in the descending order of the values as keys and a predetermined number of high-order keyword information pieces may be taken out as second candidates.

The control section 11 sets the evaluation factor of a condition that both keyword information pieces are contained about combination of any two keyword information pieces contained in the second candidates, for example.

That is, the information collection support apparatus 1 of the embedment operates as follows: Usually, the user uses the information collection support apparatus 1 to execute various types of work of creating a document (for example, work of creating a word processor document or creating an electronic mail document), acquiring a document from a web server or a document management system or receiving a document by electronic mail and browsing (reading), transferring, deleting, etc., the document. The control section 11 records the work descriptions as logs.

The information collection support apparatus 1 adopts a predetermined document group as extraction target documents, forms a Bayesian network to calculate the probability that each of the extraction target documents will be determined important based on predetermined evaluation factors, and retains the information.

The information collection support apparatus 1 also updates probability weight information concerning each evaluation factor for each user based on the user's work logs and updates the Bayesian network parameters.

If the user requests the information collection support apparatus 1 to present keywords, the information collection support apparatus 1 uses the Bayesian network parameters at the point in time when the user requests and selects a predetermined number of documents in the descending order of the probability that each document will be determined important or the documents each with the probability that the document will be determined important higher than a predetermined threshold value as important document examples from among the extraction target documents.

The information collection support apparatus 1 calculates the importance of each evaluation factor based on the probability caused by each evaluation factor about the evaluation factors related on the Bayesian network to the selected important document examples. The information collection support apparatus 1 selects a predetermined number of evaluation factors relating to keyword information in the descending order of the importance or the evaluation factors each with the importance higher than a predetermined threshold value and presents the evaluation factors to the user or uses the evaluation factors as document search keywords on the network.

Thus, according to the embodiment, the determination criterion as to whether or not the document is an important document for the user is adjusted according to the behavioral characteristics of the user. Each keyword with high importance is estimated from the document group determined important (important document examples) using the Bayesian network formed as the whole of the behavior of the user. Thus, the importance of a specific document is not directly involved in the importance of the keyword and important keywords can be presented based on the total behavior of the user.

In the embodiment, the work date and time may be related to each user's work log and the effect on the probability weight information related to the evaluation factor may be decreased according to the elapsed time since the related date and time. This method imitates the effect corresponding to the decay of long-term memory in a brain. Likewise, if the related date and time are comparatively recent, the decay of the effect may be made rapid and the effect may be decayed asymptotically to zero in a long term. Accordingly, the effect corresponding to the decay of short-term memory can be imitated. For example, the decay rate may be set like a reciprocal of an exponential function relating to the time, update amount m of probability weight information of the evaluation factor for each work log may be multiplied by decay rate α as αm, and the probability weight information may be updated by αm.

Further, if the extraction target documents are classified into electronic mail and others or data acquired from a web server, technical information, in-house documents, etc., the evaluation factor may be varied for each classification.

What is claimed is:

1. An information collection support apparatus that presents keyword information used for information collection, the information collection support apparatus comprising:
a retention unit that retains a candidate of the keyword information extracted from documents to which past work was applied by a user and probability weight information for each user to each of evaluation factors, the evaluation factors comprising evaluation factors relating to the candidate of the keyword information;
a correction unit that corrects the probability weight information based on user's work applied to the documents; and
an output unit that outputs the keyword information relevant to each document selected out of a document group using the probability weight information of the evaluation factor.

2. The information collection support apparatus as claimed in claim 1, wherein the evaluation factors relating to the candidate of the keyword information comprise an evaluation factor concerning a plurality of the candidate of the keyword information.

3. A method of information collection support that presents keyword information used for information collection, the information collection support method executed by a document processing system comprising:
a retention unit that retains a candidate of the keyword information extracted from documents to which past work was applied by a user and probability weight information for each user to each of evaluation factors, the evaluation factors comprising evaluation factors relating to the candidate of the keyword information,
the information collection support method comprising:
correcting the probability weight information based on user's work applied to the documents; and
outputting the keyword information relevant to each document selected out of a document group using the probability weight information of the evaluation factor.

4. A computer readable medium storing a program causing a computer to execute a process for presenting keyword information used for information collection,
the computer comprising:
a retention unit that retains a candidate of the keyword information extracted from documents to which past work was applied by a user and probability weight information for each user to each of evaluation factors, the evaluation factors comprising evaluation factors relating to the candidate of the keyword information, the process comprising:
correcting the probability weight information based on user's work applied to the documents; and
outputting the keyword information relevant to each document selected out of a document group using the probability weight information of the evaluation factor.

5. A computer data signal embodied in a carrier wave for presenting keyword information used for information collection, the computer comprising:
a retention unit that retains a candidate of the keyword information extracted from documents to which past work was applied by a user and probability weight information for each user to each of evaluation factors, the evaluation factors comprising evaluation factors relating to the candidate of the keyword,
the process comprising:
correcting the probability weight information based on user's work applied to the documents; and
outputting the keyword information relevant to each document selected out of a document group using the probability weight information of the evaluation factor.
